(19) United States
(12) Patent Application Publication
(10) Pub. No.: US 2011/0028545 A1
(43) Pub. Date: Feb. 3, 2011

(54) PROCESS FOR INCORPORATING ANTIMICROBIAL PRODUCTS INTO SOAP COMPOSITIONS

(75) Inventors: Gerd-Friedrich Renner, Kuerten-Biesfeld (DE); Otto Exner, Ratingen (DE); Rolf Matysiak, Duisburg (DE); Josef Wellmann, Krefeld (DE); Udo Hennen, Krefeld (DE)

Correspondence Address: LANXESS CORPORATION, 111 RIDC PARK WEST DRIVE, PITTSBURGH, PA, 15275-1112, US

(73) Assignee: LANXESS DEUTSCHLAND GMBH, Leverkusen (DE)

(21) Appl. No.: 12/811,837

(22) PCT Filed: Jan. 12, 2009
(86) PCT No.: PCT/EP09/50275

§ 371 Date: Oct. 8, 2010

(30) Foreign Application Priority Data
Jan. 17, 2008 (DE) 102008004890.9

(51) Int. Cl. A01N 37/10; A01N 31/14; A01N 47/30; A01P 1/00

(52) U.S. Cl. 514/544; 514/717; 514/596

(57) ABSTRACT

The present invention relates to a process for producing concentrates of antimicrobial active ingredients, the concentrates themselves and their use for producing solid, liquid or pasty body cleaning compositions, such as in particular soaps.

The present invention relates to a process for producing concentrates of antimicrobial active ingredients, to the concentrates themselves, and to their use for producing solid, liquid or pasty body cleaning compositions, such as in particular soaps.

Solid, liquid or pasty cleaning compositions, such as in particular soaps, comprise substances such as, for example, alkaline metal salts of saturated or unsaturated fatty acids which can be readily decomposed by microorganisms. This produces degradation products which reduce the cleaning effect and often cause an undesired change in smell. Consequently, and against the background of a desired antimicrobial action, body cleaning compositions typically comprise antimicrobial active ingredients.

For example, the production of bar soaps takes place in such a way that, in a first step, soap pellets are produced by admixing the base soap present following saponification of the parent fat or oil, which usually has a water fraction of ca. 30 to 40% by weight, with additives, such as, for example, glycerol and complexing agents, and then drying it to a water content of from 5 to 25% by weight. In a second step, the soap pellets are mixed with further additives, such as, for example, fragrances, dyes, pigments, optical brighteners, antimicrobial active ingredients or deodorizing additives, and homogenized by means of suitable mixing units. The resulting soap composition can then be passed by means of a cutting device to a bar press to produce the bar soaps.

A problem of the process described above is the fact that homogeneous incorporation of the antimicrobial active ingredients usually used is difficult on account of their pulverulent consistency, but is required in order to achieve a uniform effect within the entire product but avoid a sandy feel of the end product.

Antimicrobial active ingredients that are often used here are, for example, N-(4-chlorophenyl)-N′-(3,4-dichlorophenyl)urea (also referred to as tricholorocarbanilide or TCC) triclosan (TCS) and various parabens.

In order to effect essentially homogeneous distribution in the product of the antimicrobial active ingredients, which are generally virtually insoluble in water and sparingly soluble in common surfactants, during the production of soaps, so-called slurries are usually produced which are continuously added via metering pumps to the solid soap base (also called soap noodles), which is typically conveyed via a worm gear. These slurries usually consist of up to 99% by weight of perfume oil, dyes or dye preparations and, if required, mostly liquid, perfume-soluble further constituents for improving application technology, dermatology or toxicology. On account of the restrictions due to legal stipulations, the use of solvents, solubility promoters, emulsifiers or specific surfactants is subject to extremely narrow limits and would in any case also require high processing complexity. According to the above process, the addition of solid ingredients is limited to a use amount of in total max. ca. 1% by weight. In total means here that often further solid, water-insoluble substances are added and these can only be distributed homogeneously in the slurry through intensive stirring. If larger amounts of the water-insoluble substances are to be metered in, there is the option of initially weighing solids via metering screw, or belt weigher. However, the aforementioned problem of dust arises here.

A further option of adding the antimicrobial active ingredients, which are usually virtually insoluble in water and sparingly soluble in customary surfactants, consists in using mixers, such as, for example, kneaders, Z mixers or similar devices with a suitable discharge device. The soap noodle is initially introduced in this process, all of the other formulation constituents required are added in the supply form and mixed homogeneously at room temperature or with cooling. By means of this process it is possible, without adding further solvents, to add up to 15% by weight of solid or pasty constituents to the soap noodles. However, due to the resulting batch operation with high time and personnel expenditure, this procedure becomes uneconomical, and furthermore the problem of dust formation arising is not solved.

There was therefore the need to provide a process which permits the homogeneous incorporation of an antimicrobial active ingredient into solid, liquid or pasty cleaning compositions, such as in particular soaps.

We have now found a process for producing body cleaning compositions, such as in particular soaps, which is characterized in that concentrates according to the invention are mixed with a body cleaning composition base such that the content of one or more antimicrobial active ingredients in the body cleaning compositions overall is 0.05 to 5% by weight, preferably 0.05 to 1.5% by weight. The body cleaning compositions are preferably liquid, pasty or solid, particularly preferably pasty or solid.

A suitable body cleaning composition base is, for example, soaps or synthetic detergents, such as, for example, anionic, nonionogenic, ampholytic or zwitterionic surfactants, but preferably soaps. Soaps are preferably those soaps which contain salts of linear fatty acids having 12 to 22 carbon atoms, such as, for example, salts of lauric acid, myristic acid, palmitic acid, stearic acid, arachic acid, behenic acid, palmitoleic acid, oleic acid, linoleic acid, linolenic acid, arachidonic acid and erucic acid or mixtures thereof.

Particular preference is given to soaps which are obtainable from vegetable and animal oils and fats by saponification, for example from coconut oil fatty acids or tallow fatty acids, or mixtures thereof such as in particular mixtures of 50 to 90% by weight of C₁₆-C₁₈ tallow fatty acids and 10 to 40% by weight of C₁₂-C₁₄ coconut fatty acids.

Preferred salts of linear fatty acids are alkali metal salts such as potassium and sodium salts, preference being given to sodium salts.

The mixing can take place in a manner known per se using customary mixing elements, preferably using an extrusion press or a kneader.

The concentrates according to the invention comprise 5 to 80% by weight of one or more antimicrobial active ingredients and also 40 to 80% by weight of salts of linear fatty acids. Preferably, the fraction of antimicrobial active ingredients is 20 to 60% by weight, particularly preferably 40 to 60% by weight. Preferred antimicrobial active ingredients are parabens, TCC and TCS, or mixtures thereof, particular preference being given to TCS and TCC and very particular preference being given to TCC.

The present invention therefore further provides the use of parabens, TCC and TCS for producing the concentrates according to the invention.

Where necessary, additives can furthermore be added to the concentrates, such as, for example, water, polyalcohols, such as, for example, glycerol or polyethylene glycols, fragrances, such as, for example, cinnamaldehyde, coumarin, benzylideneheptanal, limonene, eugenol, heliotropin, vanillin, maltol, musk ketone, musk xylene; dyes, such as, for example, nitro dyes, azo dyes, indigo dyes, phthalocyanine dyes; inorganic or organic pigments; optical brighteners, such as, for example, stilbene derivatives or coumarin derivatives, or deodorizing additives, such as, for example, aluminum chloride.

To produce the concentrates, the procedure may, for example, involve intensively mixing a body cleaning composition base, such as, for example, that specified above, with the antimicrobial active ingredient or ingredients and optionally the aforementioned additives. The intensive mixing can take place here in a manner known per se using customary mixing elements, preferably using an extrusion press or a kneader. Depending on the design of the mixing element, according to the invention, soap noodles, pellets or granules with a high concentration of antimicrobial active ingredients are obtained.

The process according to the invention and the concentrates according to the invention are suitable in particular for producing bar soaps and medical washing products.

A particular advantage of the concentrates according to the invention is that, being an easy-to-handle component, they can be integrated into the customary process of soap manufacture, and in particular considerably reduce the problems, described in the prior art, of homogeneous distribution, dust behavior and undesired auxiliaries in the end product.

Furthermore, the preparation according to the invention of cleaning compositions permits the complex pretreatment of the added antimicrobial active ingredients, such as, for example, dissolving and making a paste, if appropriate at elevated temperature. Furthermore, as a result, the formation of by-products or degradation products is minimized.

### EXAMPLES

### Examples 1 to 5

### Preparation of the Concentrates According to the Invention

Soap pellets are were initially introduced into a 10 1 kneader and the desired amount of standard commercial TCC, together with a pre-given amount of solvent, are added, and mixing is carried out for 15 to 30 minutes, at least until homogeneous distribution. Then, the resulting mixture is discharged and compressed using an extrusion press via a perforated disk to give the concentrate in pellet form.

| | 1% | 2% | 3% | 4% | 5% |
|---|---|---|---|---|---|
| Soap pellets type 1 | 54 | 45 | | | |
| Soap pellets type 2 | | | 46 | 46 | 46 |
| TCC | 36 | 45 | 50 | 50 | 50 |
| Water addition | 10 | 10 | 4 | | |
| Glycerol 86% | | | | 4 | |
| strength | | | | | |
| PEG 600 | | | 4 | | |
| PEG 350 | | | | | 4 |

Type 1 tallow-based soap
Type 2 vegetable-oil-based soap
Note:
% data refer to % by weight

### Examples 6 to 10

### Production of Bar Soaps

The concentrate prepared according to example 3 was mixed with the components given below using an extrusion press with perforated disk. This operation was repeated three times. Then, a stand was extruded and bar soaps were produced from this strand.

| | | |
|---|---|---|
| Soap (prepared from 85% tallow fatty acid/15% | 4923.5 | g |
| coconut fatty acid): | | |
| Concentrate according to example 3: | 150 | g |
| Perfume fragrance C 16: | 70 | g |
| CI 11680 | 1.4 | g |
| CI 74260 | 0.05 | g |
| CI 77891 | 5 | g |

The procedure was carried out analogously with the concentrates according to examples 1, 2, 4 and 5. Without exception, bar soaps with a homogeneous distribution of the TCC were obtained.

What is claimed is:

1. A concentrate comprising in total 5 to 80% by weight of one or more antimicrobial active ingredients and also 40 to 80% by weight of salts of linear fatty acids.

2. The concentrate as claimed in claim 1, characterized in that the fraction of one one or more antimicrobial active ingredients overall is 20 to 60% by weight.

3. The concentrate as claimed in claim 1 or 2, characterized in that the antimicrobial active ingredients are selected from the group of parabens, N-(4-chlorophenyl)-N-(3,4-dichlorophenyl)urea and triclosan.

4. The concentrate as claimed in one of claims 1 to 3, characterized in that they furthermore comprise additives where the additives are selected from the group consisting of water, polyalcohols, fragrances, dyes, pigments, optical brighteners or deodorizing additives.

5. A process for producing body cleaning compositions, characterized in that a concentrate as claimed in one of claims 1 to 4 is mixed with a body cleaning composition base such that the content of one or more antimicrobial active ingredients in the body cleaning composition overall is 0.05 to 5% by weight.

6. The process as claimed in claim 5, characterized in that soaps or synthetic detergents are used as body cleaning composition base.

7. A bar soap or medicinal washing product obtainable by the process as claimed in claims 5 or 6.

8. The use of concentrates as claimed in one of claims 1 to 4 for producing body cleaning compositions.

9. A process for producing concentrates as claimed in one of claims 1 to 4, characterized in that a body cleaning composition base are mixed with the antimicrobial active ingredient or ingredients and optionally the additives.
